(19) United States
(12) Patent Application Publication
(10) Pub. No.: US 2018/0107279 A1
(43) Pub. Date: Apr. 19, 2018

(54) APPLICATIONS, SYSTEMS, AND METHODS FOR FACILITATING EMOTIONAL GESTURE-BASED COMMUNICATIONS

(71) Applicant: Afarin Pirzadeh, Indianapolis, IN (US)

(72) Inventor: Afarin Pirzadeh, Indianapolis, IN (US)

(21) Appl. No.: 15/567,813

(22) PCT Filed: Apr. 20, 2016
(86) PCT No.: PCT/US16/28494

§ 371 Date: Oct. 19, 2017

Related U.S. Application Data
(60) Provisional application No. 62/150,069, filed on Apr. 20, 2015.

(51) Int. Cl. G06F 3/01; H04M 1/725; H04W 4/14; G06F 3/0482; G06F 3/0488

(52) U.S. Cl. CPC G06F 3/017; G06F 3/016; G06F 3/04883; H04W 4/14; G06F 3/0482; H04M 1/72552

(57) ABSTRACT

The disclosure of the present application provides applications, systems, and methods for communicating emotions in conjunction with text-based, electronic communications between at least a first user and a second user. More particularly, applications and methods are provided that enable a user to incorporate emotional cues into text-based electronic communications through the use of an electronic gesture board configured to receive touch, motion, and/or gesture input, assign an emotional value to such input, and transmit the assigned emotional value to a second user such that the second user receives a visual depiction associated with the touch, motion, and/or gesture input such as one or more gesture icons, face icons, body icons, sign/symbols, or vibrations or other haptic feedback corresponding with the input emotional value. Applications, systems, and methods are also provided for customizing the visual output associated with particular touch, motion, and/or gesture input received by the gesture board.

### PRIORITY

This application is related to and claims the priority benefit of U.S. Provisional Patent Application Ser. No. 62/150,069 to Pirzadeh, filed Apr. 20, 2015. The content of the aforementioned priority application is hereby incorporated by reference in its entirety into this disclosure.

### BACKGROUND

Technology has revolutionized the way people communicate. People use a variety of media to enhance and extend interpersonal communication depending on social, security, or efficiency factors such that the close proximity of individuals communicating is no longer required. Communication modalities, however, can significantly affect the quantity and quality of the information being conveyed/received and can greatly influence senders' and receivers' behavior and attitudes with respect to the information being transmitted or even the person which whom they are communicating.

Most text-based communications lack the nuance and expression of spoken and/or face-to-face communication, which can greatly reduce the overall communication experience both in terms of satisfaction and understanding. This is not surprising as it is estimated that in everyday, face-to-face communication only seven percent (7%) of peoples' emotional communication stems from spoken words, with at least thirty-eight percent (38%) attributed to verbal tone and fifty-five percent (55%) derived from facial expression. Instant messaging (“TM”), as one example of a synchronous text-based computer-mediated communication (“CMC”), is no exception to this phenomenon. Despite the advantages of IM communication over face-to-face communication (e.g., convenience, mobility, and control), the complete absence of nonverbal cues (both visual and aural) prevent individuals from accessing/using a large component of typical human interaction and communication techniques and, thus, can significantly hinder such individuals' overall communication.

The dramatically increasing use of CMC—and text-based messaging in particular—for interpersonal communication in everyday life has significantly increased the demand for an effective way to facilitate the accuracy and overall ease of this type of communication. While conventional CMC applications continue to lack adequate methods for communicating visual and aural nonverbal cues, the limitations of these technologies with respect to emotional communication have created opportunities for designers and researchers in the area of human-computer interaction (“HCl”) and design. To date, several design solutions exist that attempt to address the lack of visual and aural nonverbal behaviors over text-based communication or otherwise seek to support users in emotional and social communication via IM:

Emoticons: Text-based communications may include emoticons (or pictorial representations of a facial expression using punctuation marks, numbers, and letters) to convey an intended mood or feeling that simple text may lack.
Avatars: Certain IM applications may integrate a graphical representation of a user or user's alter ego or character (i.e. an avatar) and use automated facial expression recognition to display such user's emotion via the avatar to a chat partner. In other IM applications, the emotion of a user may be detected by analyzing the emotional content of such user's typed text and automatically transferring the emotional content to—and displaying the same with—the user's avatar.
Haptics: Haptic IM attaches emotional meaning to waveforms with different frequencies, amplitudes, and durations and then transfers that meaning using haptic devices (e.g., joysticks and/or touchpads).
Dynamic Typography: Kinetic typography incorporates the real-time modification of text, including the font, color and size of the text, in IM applications. It may be an animation technique that mixes motion and text to express ideas and/or evoke a particular emotion.
The above-listed methods are a start towards solving the emotional void so often associated with text-based communication; however, all of these conventional solutions include one or more design and/or cost limitations and fail to adequately improve emotional and social communication via the text-based communication medium. Accordingly, there is a need for text-based systems, methods, and communication applications that are easy to implement, learn, and use and that are capable of improving emotional communication through text-based communication modalities in an efficient and cost effective manner.

### BRIEF SUMMARY

The present disclosure provides applications, systems, and methods for communicating emotions during a text-based communication session between two or more users. In at least one exemplary embodiment of such a system, the system comprises an environment comprising a means for transmitting data between a first user device and a second user device (for example, a network-based computer system), the means comprising at least electronic messaging functionality (for example, an instant messaging program, an e-mail program, or the like); and a first user device associated with the first user and a second user device associated with a second user. Each user device of the system comprises a processor in communication with at least one storage device and comprising software, at least one input component capable of receiving an input value comprising a touch or motion gesture at least through a touchscreen or a haptic interface, and an application for execution with the software, the application in communication with at least one database. Additionally, the application is configured to: (a) receive an input value entered through the at least one input component of the device, (b) pursuant to a predefined rule, associate the received input value with an output value comprising a visualization representative of the input value, and (c) transmit the output value to the other user.

In at least one additional embodiment of the system, the received input value may further comprise an emotional cue. There, the output value of the system may optionally further comprise an image that provides a visualization of at least one of gestures, face icons, body icons, signs, or symbols that correspond to the emotional cue of the received input value. In such cases, a visual element of the output value may also be representative of a degree of intensity associated with the emotional cue. For example, the visual element may comprise an increased size of the visualization of the output value when the degree of intensity associated with the emotional cue is high relative to a standard intensity value. Conversely, the visual element may comprise a decreased size of the visualization of the output value when the degree of intensity associated with the emotional cue is low relative to a standard intensity value.

Additionally or alternatively, the output value may comprise a force representative of the emotional cue of the received input value. The force may comprise, for example, a vibration or the like. Where the output value comprises a force representative of the emotional cue, a force element of the output value may be representative of a degree of intensity associated with the emotional cue. For example, in at least one embodiment, the force element comprises an increased vibrational force associated with the output value when the degree of intensity associated with the emotional cue is high relative to a standard insanity value.

In certain embodiments of the system hereof, the input component of each user device comprises an electronic gesture board. Regarding the user devices of the system, at least one of the user devices may be selected from a group consisting of a computer, a laptop, a handheld device, a tablet, a smartphone, a mobile telephone, and a wearable. Additionally, where the user devices comprise handheld devices, in at least one embodiment of the system, each application comprises a mobile application. Each application of the system may be configured to transmit the output value to the other user in real or near real-time using the means for transmitting data of the environment. In at least one embodiment, the environment comprises a network-based environment.

Furthermore, in at least one embodiment of the system, the applicable user may define the input value and the output value representative of the input value. The number of different input values is exponential. For example, input values may comprise tracing a u-curve shape on the at least one input component. In such embodiment, the output value associated therewith may comprise a menu of visualizations and words representative of an emotion comprising happiness. Likewise, where the input value comprises tracing an inverted u-curve shape on the at least one input component, the output value may comprise a menu of visualizations and words representative of an emotion comprising sadness. Additionally or alternatively, the input value may comprise tracing a zig-zag shape on the at least one input component and the output value associated therewith may comprise a menu of visualizations and words representative of an emotion comprising anger. Other potential embodiments may include where the input value comprises tracing a backslash on the at least one input component and the output value comprises a menu of visualizations and words representative of an emotion comprising annoyance, and/or where the input value comprises tracing a check-mark on the at least one input component, the output value comprises a menu of visualizations and words representative of an emotion comprising approval, and/or where the input value comprises tracing a question mark shape on the at least one input component, the output value comprises a menu of visualizations and words representative of an emotion comprising puzzlement or confusion, and/or where the input value comprises tracing a heart shape on the at least one input component, the output value comprises a menu of visualizations and words representative of an emotion comprising love.

Novel methods of communicating emotions during a text-based communication session between at least a first user and a second user are also provided. In at least one exemplary embodiment, the method comprises the steps of: inputting, by a first user, one or more emotional cues through touch or motion gestures on an input component of a first user device; and transmitting the one or more inputted emotional cues to a second user (in real time, near real-time, or otherwise), wherein the second user receives an output value comprising at least one of a visualization or a vibration that corresponds with the one or more emotional cue inputted by the first user. In certain optional embodiments of the method, the visualization may comprise at least one of a gesture, a face icon, a body icon, a sign, or a symbol representatives of the emotional cue inputted by the first user.

In the methods hereof, the input component of the first user device may comprise an electronic gesture board and/or at least one of the user devices may be selected from a group consisting of a computer, a laptop, a handheld device, a tablet, a smartphone, a mobile telephone, and a wearable. Additionally or alternatively, the output value may further comprise an image that provides a visualization of at least one of gestures, face icons, body icons, signs, or symbols that correspond to the one or more emotional cues inputted by the first user. Still further, the output value may comprise a force representative of the one or more emotional cues inputted by the first user (such as a vibration, for example). In particular embodiments of the methods described herein, the method may additionally comprise the step of defining the one or more emotional cues and the output value, wherein the definition of the output value is representative of the one or more emotional cues. This step may be performed by the first user, for example. Accordingly, in such cases, the method may be completely—or at least partially—customizable.

In addition to the foregoing, the methods hereof may further comprise the step of associating, pursuant to a predefined rule, the one or more emotional cues inputted by the first user with the output value, wherein the output value is representative of the inputted one or more emotional cues. There, the first user may establish the predefined rule and/or the first user may set the value of the output value representative of a particular emotional cue.

Still further, the aforementioned method step of inputting may further comprise the steps of: displaying a menu of visualizations and words representative of the one or more emotional cues; and selecting, by the first user at least one of the visualizations or words on the menu for inclusion in the output value. In such cases, the step of inputting may comprise tracing, by the first user, a u-curve shape on the input component and the visualizations and words may be representative of an emotion comprising happiness. Alternatively, the step of inputting may comprise tracing, by the first user, an inverted u-curve shape on the at least one input component and the visualizations and words may be representative of an emotion comprising sadness. Other embodiments include the step of inputting comprising tracing, by the first user, a zig-zag shape on the at least one input component, with the visualizations and words representative of an emotion comprising anger. The step of inputting may also comprise tracing, by the first user, a backslash on the at least one input component, where the resulting visualizations and words are representative of an emotion comprising annoyance, and/or the step of inputting may comprise tracing, by a first user, a check-mark on the at least one input component and the visualizations and words are representative of an emotion comprising approval. Still further, the step of inputting may comprise tracing, by the first user, a question mark shape on the at least one input component and the visualizations and words may be representative of an emotion comprising puzzlement or confusion, and/or the step of inputting may comprise tracing, by the first user, a heart shape on the at least one input component, with the visualizations and words representative of an emotion comprising love.

Other exemplary methods of the present disclosure may, in addition to the aforementioned steps, additionally comprise the step of associating a degree of intensity with the one or more emotional cues inputted by the first user. This step may optionally further comprise the step of establishing a standard intensity value. Still further, such methods may comprise the step of displaying the output value to the second user, wherein a visual element and/or force element of the output value is representative of the degree of intensity associated with the one or more emotional cues inputted by the first user.

Additional embodiments of the present disclosure comprise a software application for communicating emotions during a text-based communication session between at least a first user and a second user. In at least one exemplary embodiment of such a software application, the application comprises an executable program codes operable to (a) receive an input value entered through the at least one input component of the device, (b) pursuant to a predefined rule, associate the received input value with an output value comprising a visualization representative of the input value, and (c) transmit the output value to the other user.

### BRIEF DESCRIPTION OF THE DRAWINGS

The disclosed embodiments and other features, advantages, and disclosures contained herein, and the matter of attaining them, will become apparent and the present disclosure will be better understood by reference to the following description of various exemplary embodiments of the present disclosure taken in conjunction with the accompanying drawings, wherein:

FIGS. 1A and 1B show schematic/block diagrams of the underlying software and hardware of an electronic messaging system according to an exemplary embodiment of the present disclosure

FIG. 2 shows a screenshot of a user interface representative of a message thread between two users who have sent and received conventional text-based messages using the electronic messaging system;

FIGS. 3A-3E show screenshots of various embodiments of a user interface associated with a gesture page of an electronic messaging application according to the present disclosure;

FIGS. 4A-4C show screenshots of at least one embodiment of a user interface associated with a gesture page and verification page of an embodiment the electronic messaging application according to the present disclosure;

FIG. 5 shows a flow chart depicting various steps of a method for communicating emotions during a text-based communication session between a first and a second user using the electronic messaging application according to the present disclosure;

FIGS. 6A-24C show screenshots of embodiments of user interfaces displaying embodiments of input and output values received and derived, respectively, by the electronic messaging application according to the present disclosure; and

FIGS. 25-26H show screenshots of embodiments of user interfaces displaying embodiments of a tutorial provided by the electronic messaging application according to the present disclosure and various aspects of the feature sets thereof.

The flow charts and screen shots depicted in the Figures are representative in nature and actual embodiments of the applications, systems, and methods hereof may include further features or steps not shown in the drawings. The exemplification set out herein illustrates an embodiment of the systems and methods, in one form, and such exemplifications are not to be construed as limiting the scope of the invention in any manner.

An overview of the features, functions and/or configurations of the components depicted in the various figures will now be presented. It should be appreciated that not all of the features of the components of the figures are necessarily described. Some of these non-discussed features, as well as discussed features, are inherent from the figures themselves. Other non-discussed features may be inherent in component geometry and/or configuration.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is intended, with any additional alterations, modifications, and further applications of the principles of this disclosure being contemplated hereby as would normally occur to one skilled in the art. Accordingly, this disclosure is intended to cover alternatives, modifications, and equivalents as may be included within the spirit and scope of this application as defined by the appended claims. While this technology may be illustrated and described in a preferred embodiment, the systems, methods, and techniques hereof may comprise many different configurations, forms, materials, and accessories.

For example, the applications, systems, and methods of the present application will be described in the context of a text-based communication modality that facilitates the communication of emotions between two or more individuals in conjunction with text-based information transfer (for example, and without limitation, conventional IM or text messaging modalities). It should be noted that the applications, systems, and methods hereof are not limited in application to stand-alone text-based communication platforms (such as text messaging for example), but rather embodiments may be utilized in and/or customized for any type of computer-based system that employs some form of text-based communication application including, but not limited to, multi-faceted social networking platforms and the like.

In the following description, numerous specific details are set forth in order to provide a thorough understanding of the present disclosure. Particular examples may be implemented without some or all of these specific details. In other instances, well-known process operations and/or system configurations have not been described in detail so as to not unnecessarily obscure the present disclosure.

Various techniques and mechanisms of the present disclosure will sometimes describe a connection between two components. Words such as attached, affixed, coupled, connected, and similar terms with their inflectional morphemes are used interchangeably unless the difference is expressly noted or made otherwise clear from the context. These words and expressions do not necessarily signify direct connections, but include connections through mediate components and devices. Indeed, it should be noted that a connection between two components does not necessarily mean a direct, unimpeded connection, as a variety of other components may reside between the two components of note. For example, a workstation may be in communication with a server, but it will be appreciated that a variety of bridges and controllers may reside between the workstation and the server. Consequently, a connection does not necessarily mean a direct, unimpeded connection unless otherwise noted.

Furthermore, wherever feasible and convenient, like reference numerals are used in the figures and the description to refer to the same or like parts or steps. The drawings are in a simplified form and not to precise scale.

The detailed descriptions which follow are presented, in part, in terms of algorithms and symbolic representations of operations on data bits within a computer memory representing alphanumeric characters or other information. A computer generally includes a processor for executing instructions and memory for storing instructions and data. When a general purpose computer has a series of machine encoded instructions stored in its memory, the computer operating on such encoded instructions may become a specific type of machine, namely a computer particularly configured to perform the operations embodied by the series of instructions. Some of the instructions may be adapted to produce signals that control operation of other machines and thus may operate through those control signals to transform materials far removed from the computer itself. These descriptions and representations are the means used by those skilled in the art of data processing arts to most effectively convey the substance of their work to others skilled in the art.

An algorithm is here, and generally, conceived to be a self-consistent sequence of steps leading to a desired result. These steps are those requiring physical manipulations of physical quantities. Usually, though not necessarily, these quantities take the form of electrical or magnetic pulses or signals capable of being stored, transferred, transformed, combined, compared, and otherwise manipulated. It proves convenient at times, principally for reasons of common usage, to refer to these signals as bits, values, symbols, characters, display data, terms, numbers, or the like as a reference to the physical items or manifestations in which such signals are embodied or expressed. It should be kept in mind, however, that all of these and similar terms are to be associated with the appropriate physical quantities and are merely used here as convenient labels applied to these quantities.

Some algorithms may use data structures for both inputting information and producing the desired result. Data structures greatly facilitate data management by data processing systems, and are not accessible except through software systems. Data structures are not the information content of a memory, but rather represent specific electronic structural elements that impart or manifest a physical organization of the information stored in memory. More than mere abstraction, the data structures are specific electrical or magnetic structural elements in memory which simultaneously represent complex data accurately, often data modeling physical characteristics of related items, and provide increased efficiency in computer operation.

Further, the manipulations performed are often referred to in terms commonly associated with mental operations performed by a human operator (such as “comparing” or “adding”). No such capability of a human operator is necessary (or desirable in most cases) in any of the operations described herein which form part of the embodiments of the present application; instead, the operations are machine operations. Indeed, a human operator could not perform many of the machine operations described herein due, at least in part, to the automated updating functionality, networking, and vast distribution capabilities of the present disclosure.

Useful machines for performing the operations of one or more embodiments hereof include general purpose digital computers, microprocessors, small computing devices (including without limitation handheld computers such as smartphones, tablets, and the like), or other similar devices. As used herein, the term “computer” shall mean and include all of the aforementioned and any variants thereof that are now known or hereinafter developed. In all cases the distinction between the method operations in operating a computer and the method of computation itself should be recognized. One or more embodiments of the present disclosure relate to methods and apparatus for operating a computer in processing electrical or other physical signals (e.g., mechanical or chemical) to generate other desired physical manifestations or signals (for example, physical vibrations of the device or a related accessory or the graphical depiction of an emotion or other symbol). The computer and systems described herein operate on one or more software modules, which are collections of signals stored on a media that represents a series of machine instructions that enable the computer processor to perform the machine instructions that implement the algorithmic steps. Such machine instructions may be the actual computer code the processor interprets to implement the instructions or, alternatively, may be a higher level coding of the instructions that is interpreted to obtain the actual computer code. The software module may also include a hardware component where some aspects of the algorithm are performed by the circuitry itself rather as a result of an instruction.

Some embodiments of the present disclosure also relate to an apparatus or specific hardware for performing the disclosed operations. This apparatus and/or hardware may be specifically constructed for the required purposes or it may comprise a general purpose computer, device, or related hardware as selectively activated, employed, or reconfigured by a computer program stored in the computer. The algorithms presented herein are not inherently related to any particular computer or other apparatus unless explicitly indicated as requiring particular hardware. In some cases, the computer programs may communicate or relate to other programs or equipment through signals configured to particular protocols which may or may not require specific hardware or programming to interact (e.g., in at least one embodiment, the computer programs use a set of predefined APIs (defined below)). In particular, various general purpose machines may be used with programs written in accordance with the teachings herein or it may prove more convenient to construct at least one or more specialized apparatus—or retrofit an existing apparatus—to perform the required method steps. The required structure for a variety of these machines will appear from the description below.

Embodiments of the present invention may deal with “object oriented” software, and particularly with an “object oriented” operating system. The “object oriented” software is organized into “objects,” each comprising a block of computer instructions describing various procedures (“methods”) to be performed in response to “messages” sent to the object or “events” which occur with the object. Such operations include, for example, the manipulation of variables, the activation of an object by an external event, and the transmission of one or more messages to other objects.

Messages (as they relate to internal computer operations and programming) are sent and received between objects having certain functions and knowledge to carry out processes. Messages may be generated in response to user instructions, for example, by a user activating an icon with a “mouse” pointer generating an event. Also, messages may be generated by an object in response to the receipt of a message. When one of the objects receives a message, the object carries out an operation (a message procedure) corresponding to the message and, if necessary, returns a result of the operation. Each object has a region where the internal states (instance variables) of the object itself are stored and where the other objects are not allowed to access. One feature of the object oriented system is inheritance. For example, an object for drawing a “circle” on a display may inherit functions and knowledge from another object for drawing a “shape” on a display.

A programmer “programs” in an object-oriented programming language by writing individual blocks of code each of which creates an object by defining its methods. A collection of such objects adapted to communicate with one another by means of messages comprises an object-oriented program. Object-oriented computer programming facilitates the modeling of interactive systems in that each component of the system can be modeled with an object, the behavior of each component being simulated by the methods of its corresponding object, and the interactions between components being simulated by messages transmitted between objects.

An operator may stimulate a collection of interrelated objects comprising an object oriented program by sending a message to one of the objects. The receipt of the message may cause the object to respond by carrying out predetermined functions which may include sending additional messages to one or more other objects. The other objects may in turn carry out additional functions in response to the messages they receive, including sending still more messages. In this manner, sequences of message and response may continue indefinitely or may come to an end when all messages have been responded to and no new messages are being sent. When modeling systems utilize an object oriented language, a programmer need only think in terms of how each component of a modeled system responds to a stimulus and not in terms of the sequence of operations to be performed in response to some stimulus. Such sequence of operations naturally flows out of the interactions between the objects in response to the stimulus and need not be preordained by the programmer.

Although object oriented programming makes simulation of systems of interrelated components more intuitive, the operation of an object-oriented program is often difficult to understand because the sequence of operations carried out by an object oriented program is usually not immediately apparent from a software listing as in the case for sequentially organized programs. Nor is it easy to determine how an object oriented program works through observation of the readily apparent manifestations of its operation. Most of the operations carried out by a computer in response to a program are “invisible” to an observer since only a relatively few steps in a program typically produce an observable computer output.

In the following description, several terms which are used frequently have specialized meanings in the present context. The terms “network,” “local area network,” “LAN,” “wide area network,” or “WAN” mean two or more computers that are connected in such a manner that messages may be transmitted between the computers. In such networks, typically one or more computers operate as a “server,” which run(s) one or more applications capable of accepting requests from clients and giving responses accordingly (and which, optionally, may also include a server operating system on top of which the other programs/applications run). Servers can run on any computer including dedicated computers, which individually are also often referred to as “the server” and typically comprise—or have access to—processors, memory, large storage devices (such as, for example, hard disk drives), or databases (cloud-based or otherwise) and, optionally, communication hardware to operate peripheral devices such as printers, webcams, or modems. Servers can also be configured for cloud computing, which may be Internet-based computing where groups of remote servers are networked to allow for centralized data storage. Such cloud computing systems enable users to obtain online access to computer services and/or other resources despite such users' potentially diverse geographic locations. As is known in the art, servers may comprise uninterruptible power supplies to insure against power failure, as well as hardware redundancy such as dual power supplies, RAID disk systems, ECC memory, and the like, along with extensive pre-boot memory testing and verification systems.

Other computers, termed “clients” or “workstations,” provide a user interface so that users of computer networks can access and use the network resources, such as the electronic communication applications and systems of the present disclosure. Users activate computer programs or network resources to create “processes” that include both the general operation of a computer program along with specific operating characteristics determined by input variables and its environment. It will be appreciated that, in certain embodiments, client computers that employ peer-to-peer applications need not necessarily interact with a server of the system, but may instead (or additionally) run the necessary applications locally. Indeed, in such embodiments, the systems and methods hereof need not necessarily include a separate server.

As used herein, the term “electronic messaging” means and encompasses any text-based communication functionality or service that provides for at least a single text message interchange via a client computer or other device that is connected to a network. One or more electronic messaging services may be supported by a computer or other device and may include, for example and without limitation, SMS (short message service), MMS (multimedia message service), e-mails, pin messaging, quick messaging, instant messaging (IM) and/or various chat applications (where—typically bidirectional—text transmission between two or more communicating users is provided over a network in real- or near real-time, with more advanced applications adding file transfer and clickable hyperlinks), and the like. Depending on the desired effect and particular protocols employed, the technical architecture of such electronic messaging applications can be peer-to-peer (direct point-to-point transmission) or client-server (a central server retransmits messages from the sender to the communication device). E-mail for example, may rely on a store-and-forward techniques such as an originator sending a message to a computer node where the message is stored and then forwarded to other nodes until it reaches a mailbox belonging to the intended user. Alternatively, most IM applications process the real- or near real-time transfer of messages between clients (man and machine) through a flexible distributed system or network (for example, the Internet, a LAN, a wireless wide area network such as a cellular or mobile network, or the like).

The electronic messaging functionality hereof may be provided by specific user interfaces that present a menu or display related to APIs with associated settings for the user associated with the underlying client computer. When the client accesses an electronic messaging application, which may be hosted locally or require an application program to execute on the remote server (i.e. in a case where the application is a network resource), the client calls an API, which in turn allows the user to provide commands to the messaging application and observe any output through a related user interface (“UI”) or graphical user interface “GUI.”

Certain electronic messaging applications may be delivered through a Browser. The term “Browser” refers to a program that is not necessarily apparent to the user, but is responsible for transmitting messages between the client and a network server and for displaying and interacting with a network user. Browsers are designed to utilize a communications protocol for transmission of text and graphic information over a worldwide network of computers, namely the “World Wide Web” or simply the “Web.” Examples of Browsers compatible with one or more embodiments described in the present application include, but are not limited to, the Chrome browser program developed by Google Inc. of Mountain View, Calif. (Chrome is a trademark of Google Inc.), the Safari browser program developed by Apple Inc. of Cupertino, Calif. (Safari is a registered trademark of Apple Inc.), Internet Explorer program developed by Microsoft Corporation (Internet Explorer is a trademark of Microsoft Corporation of Redmond, Wash.), the Edge Browser program developed by Microsoft Corporation (Microsoft Edge is a trademark of Microsoft Corporation of Redmond, Wash.), the Opera browser program created by Opera Software ASA, or the Firefox browser program distributed by the Mozilla Foundation (Firefox is a registered trademark of the Mozilla Foundation), or any other Browsers or like programs currently in use or hereinafter developed.

Generally, Browsers display information that is formatted in a Standard Generalized Markup Language (“SGML”) or a HyperText Markup Language (“HTML”), both being scripting languages which embed non-visual codes in a text document through the use of special ASCII text codes. Files in these formats may be easily transmitted across computer networks, including global information networks like the Internet, and allow the Browsers to display text and images. The Web utilizes these data file formats in conjunction with its communication protocol to transmit such information between servers and client computers. Browsers may also be programmed to display information provided in an eXtensible Markup Language (“XML”) file, with XML files being capable of use with several Document Type Definitions (“DTD”) and thus more general in nature than SGML or HTML. The XML file may be analogized to an API, as the data and the stylesheet formatting are separately contained (formatting may be thought of as methods of displaying information, thus an XML file has data and an associated method). Similarly, JavaScript Object Notation (JSON) may be used to convert between data file formats.

The terms “handheld device” or “smartphone” means any handheld, mobile device that combines computing, telephone, fax, electronic messaging and/or networking features. The terms “wireless wide area network” or “WWAN” mean a wireless network that serves as the medium for the transmission of data between a handheld device and a computer.

In wireless wide area networks, communication primarily occurs through the transmission of radio signals over analog, digital cellular, or personal communications service (“PCS”) networks. Signals may also be transmitted through microwaves and other electromagnetic waves. At the present time, most wireless data communication takes place across cellular systems using second generation technology such as code-division multiple access (“CDMA”), time division multiple access (“TDMA”), the Global System for Mobile Communications (“GSM”), Third Generation (wideband or “3G”), Fourth Generation (broadband or “4G”), personal digital cellular (“PDC”), or through packet-data technology over analog systems such as cellular digital packet data (CDPD”) used on the Advance Mobile Phone Service (“AMPS”).

The terms “wireless application protocol” or “WAP” mean a universal specification to facilitate the delivery and presentation of web-based data on handheld and mobile devices with small user interfaces. “Mobile software” refers to the software operating system which allows for application programs to be implemented on a mobile device such as a mobile telephone, handheld device or smartphone, tablet, or wearable. Some examples of mobile software are Java and Java ME (Java and JavaME are trademarks of Sun Microsystems, Inc. of Santa Clara, Calif.), BREW (BREW is a registered trademark of Qualcomm Incorporated of San Diego, Calif.), Windows Mobile (Windows is a registered trademark of Microsoft Corporation of Redmond, Wash.), Palm OS (Palm is a registered trademark of Palm, Inc. of Sunnyvale, Calif.), Symbian OS (Symbian is a registered trademark of Symbian Software Limited Corporation of London, United Kingdom), ANDROID OS (ANDROID is a registered trademark of Google, Inc. of Mountain View, Calif.), and iPhone OS (iPhone is a registered trademark of Apple, Inc. of Cupertino, Calif.), and Windows Phone 7. “Mobile apps” refers to software programs generally that are written for execution with mobile software.

To aid in understanding the novel concepts presented herein, a brief overview of the methods and systems and their related functionality will now be described, followed by more detailed descriptions of the components thereof and its underlying system architecture and computing environments. In general, the applications, systems, and methods disclosed herein facilitate emotional communication in conjunction with text-based electronic messaging functionalities. Perhaps more specifically, the disclosed systems and methods allow for users to easily and effectively express different emotional cues via electronic messaging through touch and motion gestures, with such touch and motion gestures being visualized by their communication partner in one or more visual or communication formats. For example, in at least one exemplary embodiment, the visual format associated with a particular emotional cue may comprise a gesture icon, face icons, body icons, signs/symbols, or even vibrations of the device. Additionally, the applications, systems, and methods hereof may also be configured such that a variety of particular visual formats and/or words are displayed in response to a particular emotional cue such that a user can efficiently choose his or her output from a menu of options that are all representative of—or related to—the inputted emotional cue.

Accordingly, the present disclosure provides a unique application that, in addition to providing the benefits and conveniences of electronic messaging, enables users to add an additional layer of emotional context to such communications, thereby increasing the understanding and efficiency of such communication methods and providing a more satisfactory experience overall. Furthermore, certain exemplary embodiments of the systems and methods hereof may establish a modality through which users can associate particular outputs (e.g., graphical images) with specific user-defined motion and/or gesture inputs. In this manner, the present disclosure provides a customizable experience that further facilitates the conveyance of emotional communication via electronic messaging.

### Computing Environments

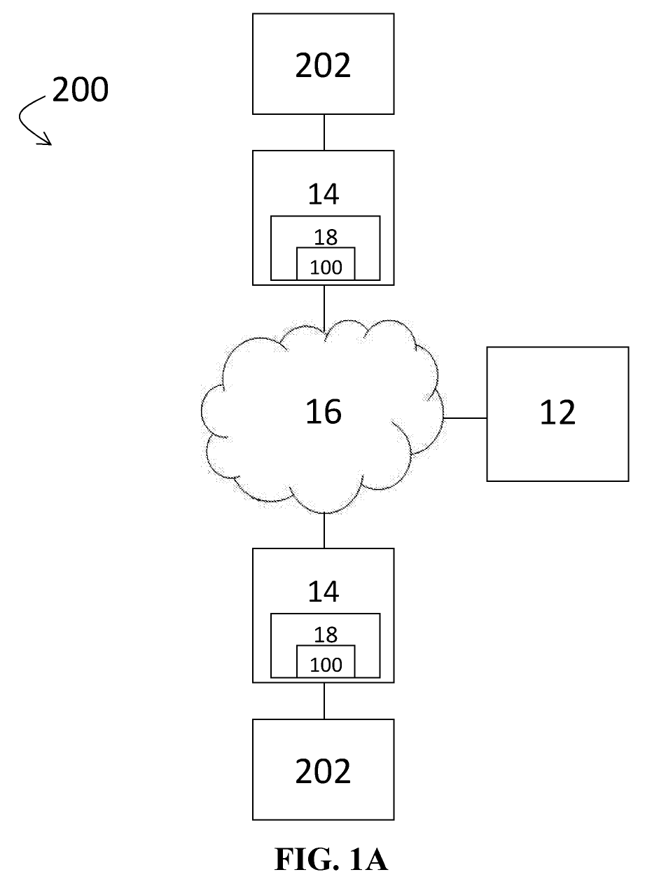

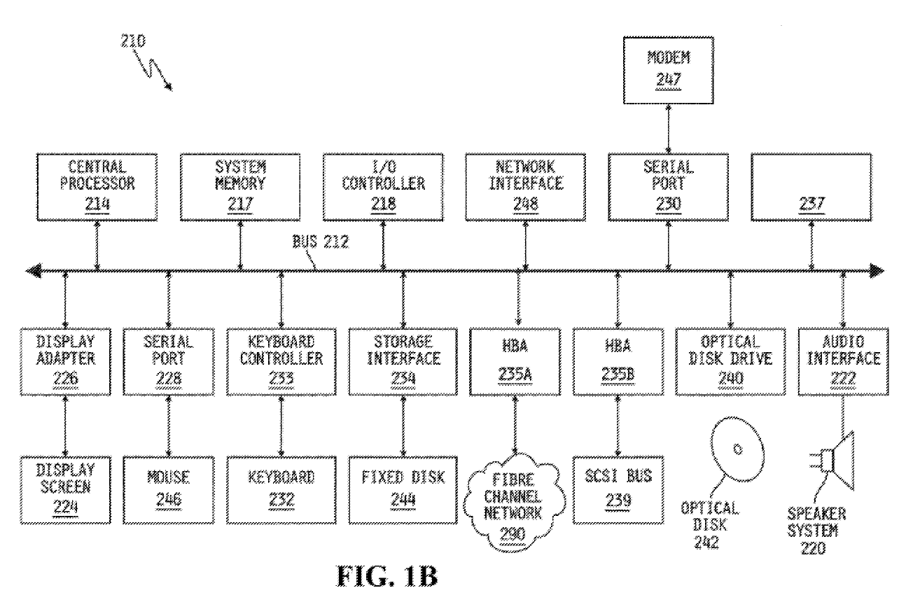

Now referring to at least one embodiment of the present disclosure, FIG. 1A is a high-level block diagram of a computing environment through which aspects of the presently disclosed electronic messaging system, applications, and methods may be implemented. The novel concepts of the present disclosure may be provided as an electronic messaging application 100 configured for implementation through a variety of system architectures.

FIG. 1A illustrates at least one embodiment of a network-based system 200 through which two or more users 202 may communicate using the electronic messaging application 100. As shown in FIG. 1A, a network-based system 200 comprises a server 12 and two clients 14 connected over a network 16. A user 202 may execute the electronic messaging application 100 in connection with software 18 on one or more of clients 14 to both send and receive messages and/or data over the network 16 via server 12 and any of its associated communications equipment and software (not shown). In at least one embodiment, the electronic messaging application 100 may comprise a stand-alone messaging application (e.g., that provides comprehensive IM functionality on the client 14) or, in at least one alternative embodiment, the electronic messaging application 100 may comprise a software component (i.e. a plug-in, add-on, or extension) that adds its specific emotional cue features to a separate (and, perhaps, third party) messaging application (present within software 18 or otherwise).

Clients 14 may each comprise hardware and componentry as would occur to one of skill in the art such as, for example, one or more microprocessors, memory, input/output devices, device controllers, and the like. For example, in at least one embodiment, each client 14 comprises a network accessible device that is capable of executing one or more applications with software 18 and/or accessing the network 16 (such as through a Browser, for example, if the network 16 is the Internet or an intranet). A client 14 may be any type of computing device or system such as, for example, a such as a personal computer, mainframe computer, workstation, notebook, tablet or laptop computer or device, handheld device, mobile telephone or smartphone, wearable, or any other computing or communications device having network interfaces (wireless or otherwise), and each client 14 of the system 200 need not comprise the same type of computing device.

Each client 14 comprises one or more input devices that are operable by a user 202 such as, for example, a keyboard, keypad, pointing device, mouse, touchpad, touchscreen, microphone, camera, webcam, sensors, haptic technologies (including non-contact haptic technologies), and/or any other data entry means, or combination thereof, known in the art or hereinafter developed. Clients 14 may also comprise visual and/or audio display means for displaying or emitting output. For example, a client 14 may comprise a CRT display, an LCD display, a printer, one or more speakers, and/or any other types of display or output devices known in the art or hereinafter developed. The exact configuration of each client 14 in any particular implementation of system 200 hereof may vary between clients 14 and, as desired, may be left to the discretion of the practitioner.

It will be appreciated that only two clients 14 are shown in FIG. 1A in order to simply and clarify the description and no limitation is intended thereby. Indeed, any number of clients 14 may employ the electronic messaging application 100 and connect with other clients 14 over the network 16. Likewise, while only one server 12 is depicted in FIG. 1A, the computing environment may comprise two, or even a plurality of, servers 12. Alternatively, the system 200 need not comprise a server 12 at all or the system 200 may comprise one or more servers 12 with one or more of the client computers 14 functioning independently thereof (i.e. running their respective applications locally, yet interacting with other users 202 over the system 200 that are utilizing the server 12 thereof).

As described above, the clients 14 of the computing environment each comprise a user interface (not shown) to facilitate a user's input into and access to the functionality of an electronic messaging application. The user interface can be any interface known in the art that is appropriate to achieve such a purpose and is fully customizable.

Furthermore, the user interface may be local to a client 14, provided over the network 16, or stored within the server 12 (where applicable). In at least one embodiment, the user interface comprises a web-based portal that provides functionality for accessing and displaying data (e.g., received electronic messages) stored within the server 12. In at least one exemplary embodiment, the user interface comprises a mobile application and/or widget designed to run on smartphones, tablet computers, wearables, and other mobile devices.

### System Hardware

Now referring to FIG. 1B, a block diagram of a computer system hardware 210 suitable for implementing electronic messaging application 100 and/or system 200 in connection with one or more clients 14 is shown. Exemplary computer systems 210 of the present disclosure include a bus 212 that interconnects major subsystems of computer system 210, such as a central processor 214 (also referred to generally as a “processor”), memory 217, one or more input/output controllers 218, optional external audio devices (such as speaker system 220 via audio output interface 222), external devices (such as display screen 224 via display adapter 226), serial ports 228 and 230, keyboards 232 (interfaced with keyboard controller 233), storage interfaces 234, optional removable storage unit 237 operative to receive removable storage devices, host bus adapter (HBA) interface cards 235A operative to connect with fiber channel network 290, HBA interface cards 235B operative to connect to SCSI busses 239, and optional optical disk drives 240 operative to receive optical disk 242, for example. Various computer systems 210 may include one or more of some or all of the foregoing. Also included, depending on the type of client 14 being utilized, may be mouse 246 (or other input devices, such as touchpads or touchscreens, coupled to bus 212 via serial port 228), modem 247 (coupled to bus 212 via serial port 230), and network interface 248 (coupled directly to bus 212).

Bus 212 allows data communication between central processor 214 and memory 217. Memory 217 may include random access memory (RAM), ECC memory (error-correcting code memory), RAID (redundant array of independent disks) disk systems, read-only memory (ROM), flash memory, external databases, or any combination of the foregoing or like (examples of which are not specifically shown). As is known in the art, RAM may generally comprise the main memory into which operating system and application programs are loaded and ROM or flash memory may contain, among other software code, Basic Input-Output system (BIOS) which controls basic hardware operation such as interaction with peripheral components; however, it is also increasingly common for cloud storage and/or external databases to be integrated into these system structures where appropriate and/or advantageous.

Applications resident with computer system 210 are generally stored on and accessed via computer readable media, such as hard disk drives (e.g., fixed disk 244), optical drives (e.g., optical drive 240), optional removable storage unit 237, the system memory 217, and/or on other storage media now known in the art or hereinafter developed. Additionally, applications may be in the form of electronic signals modulated in accordance with the application and data communication technology when accessed via network modem 247 or interface 248 or other telecommunications equipment (not shown). Furthermore, in addition to memory 217, the computer system 210 also comprises one or more databases (not shown) for storing data received by the system from users 202 or otherwise. Such databases may be any database known in the art and may, in at least one exemplary embodiment, comprise a combination of cloud storage, local database structures, and external storage.

Storage interface 234, as with other storage interfaces of computer system 210, may connect to standard computer readable media for storage and/or retrieval of information, such as fixed disk drive 244. Fixed disk drive 244 may be part of computer system 210 or may be separate and accessed through other interface systems. Modem 247 may provide direct connection to remote servers via telephone link or the Internet via an internet service provider (ISP) (not shown). In at least one embodiment, the network interface 248 may provide direct connection to remote servers 12 via a direct network link to the network 16 via a POP (point of presence). Network interface 248 may provide such connection using wireless techniques, including digital cellular telephone connection, Cellular Digital Packet Data (CDPD) connection, digital satellite data connection or the like.

Many other devices or subsystems (not shown) may be connected in a similar manner (e.g., document scanners, digital cameras and so on). Conversely, all of the devices shown in FIG. 1B need not be present to practice the present disclosure. Furthermore, devices and subsystems may be interconnected in different ways from that shown in FIG. 1B. Operation of a computer system such as that shown in FIG. 1B is readily known in the art and is not discussed in detail in this application. Software source and/or API specifications to implement the present disclosure may be stored in computer-readable storage media such as one or more of system memory 217, fixed disk 244, optical disk 242, or removable storage media received by removable storage unit 237. The operating system provided on computer system 210 may be a variety or version of either MS-DOS® (MS-DOS is a registered trademark of Microsoft Corporation of Redmond, Wash.), WINDOWS® (WINDOWS is a registered trademark of Microsoft Corporation of Redmond, Wash.), OS/2® (OS/2 is a registered trademark of International Business Machines Corporation of Armonk, N.Y.), UNIX® (UNIX is a registered trademark of X/Open Company Limited of Reading, United Kingdom), Linux® (Linux is a registered trademark of Linus Torvalds of Portland, Oreg.), various Apple® operating systems (iOSs), or other known or developed operating system. In some embodiments, computer system 210 may take the form of a handheld device, typically in the form of a tablet, smartphone or other such device having a large display touchscreen. In handheld device alternative embodiments, the operating system may be iOS® (iOS is a registered trademark of Cisco Systems, Inc. of San Jose, Calif., used under license by Apple Corporation of Cupertino, Calif.), Android® (Android is a trademark of Google Inc. of Mountain View, Calif.), Blackberry® Tablet OS (Blackberry is a registered trademark of Research In Motion of Waterloo, Ontario, Canada), webOS (webOS is a trademark of Hewlett-Packard Development Company, L.P. of Texas), and/or other suitable mobile device operating systems.

Moreover, regarding the signals described herein, those skilled in the art will recognize that a signal may be directly transmitted from a first block to a second block, or a signal may be modified (e.g., amplified, attenuated, delayed, latched, buffered, inverted, filtered, or otherwise modified) between blocks. Although the signals of the certain embodiments described herein are characterized as transmitted from one block to the next, other embodiments of the present disclosure may include modified signals in place of such directly transmitted signals as long as the informational and/or functional aspect of the signal is transmitted between blocks. To some extent, a signal input at a second block may be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

### Functionality

As previously stated, the applications, systems, and methods of the present disclosure provide an emotional communication component to text-based electronic messaging modalities. Perhaps more specifically, the electronic messaging application 100 enables users to deliver emotional context in conjunction with text-based communication over a network 16. Indeed, the application 100 introduces a new mode of gesture to electronic, text-based messaging, as well as establishes a user-defined dictionary of touch and motion gestures that facilitate emotional communication over this medium. In operation, the electronic messaging application 100 is implemented using user interfaces (“UIs”), which interact with a user 202 through various UI displays, and through various hardware for receiving user input as previously described in connection with the clients 14.

The specific functionality provided by the electronic messaging application 100 will now be described in further detail, using screenshots of UI embodiments for explanatory purposes in some cases. It will be understood, however, that these UIs are simply examples of various embodiments of the application 100 and system 200 and are not intended to be limiting in any manner. Indeed, unless otherwise expressly stated herein, the specific UIs described are fully customizable in accordance with the requirements and preferences of a user 202.

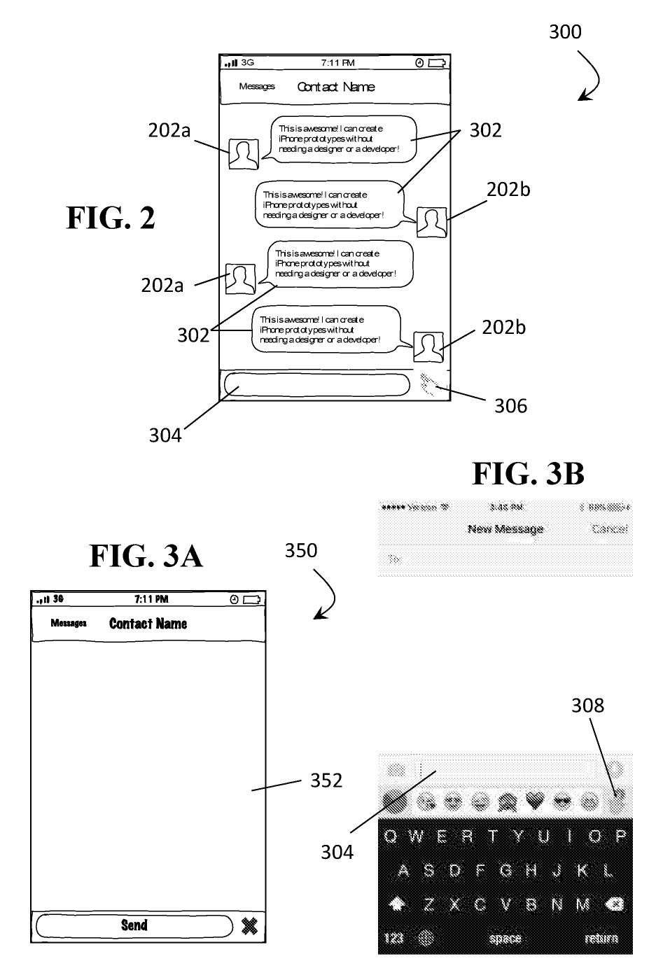

During conventional text-based, electronic messaging exchanges between two or more users 202, one or more messages are grouped into threads representative of conversations. FIG. 2 illustrates a UI 300 representative of such a message thread between two users 202, who are herein referred to as the “sender user 202a” and the “recipient user 202b,” as appropriate. As shown in FIG. 2, both users 202 have sent and received text-based messages 302 using the electronic messaging system.

As is conventionally known in the art, text-based communications are typed or keyed into the UI 300 by a sender user 202a—in this case, for example, the sender user 202a types text into field 304, elects to “send” the text-based communication to the recipient user 202b or otherwise publish the text-based communication to the system (by selecting button 306 or otherwise), and thereafter the text-based communication is “received” or otherwise accessed by the recipient user 202b. Such conventional messaging platforms do not provide comprehensive modalities for transmitting or otherwise communicating nuance in real or near real-time with respect to the messages 302, nor do they provide means for dynamically influencing the conversation or message thread with the users' 202 emotions or mood.

The electronic messaging application 100 of the present disclosure adds a “gesture mode” to the standard, static text-based messaging platforms, which allows for sender users 202a to easily incorporate emotional cues into the message thread or conversation. Such a “gesture mode” can be turned on and off at the users' 202 preference, or a system 200 may be configured such that the application 100 is an inherent component of the overall messaging platform.

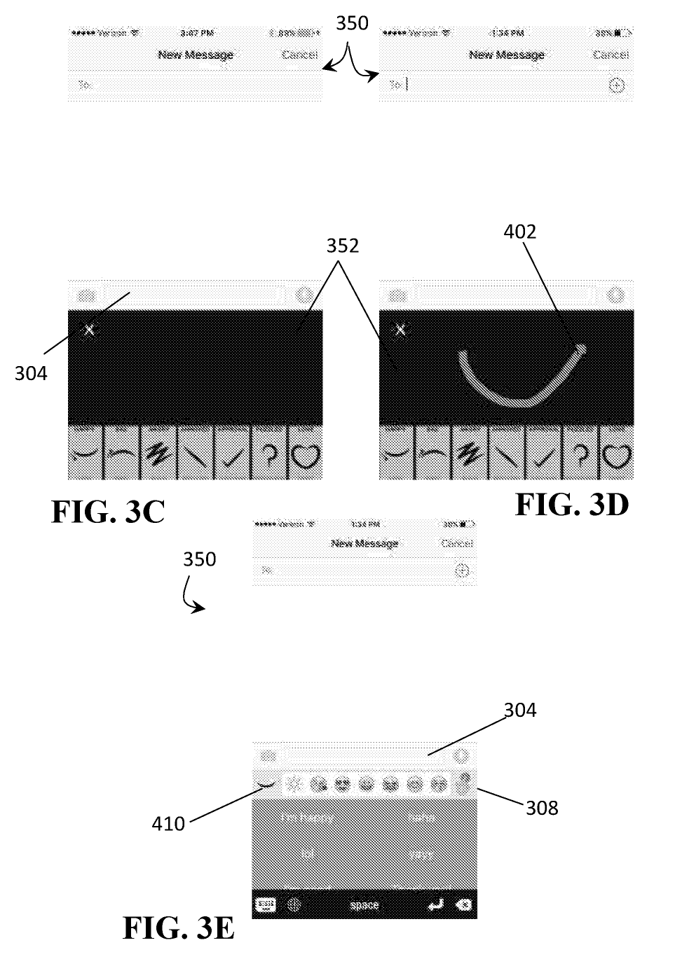

FIG. 3A shows a screenshot of at least one embodiment of a UI of a gesture page 350 that a user 202 may view after activating the electronic messaging application 100 (i.e. selecting “gesture mode,” hitting a specific key on the client 14 (e.g., see gesture mode button 308 on FIG. 3B), entering a predefined code into the client 14, and/or performing a gesture such as a vertical swipe on the screen or shaking/moving the client 14 device in a certain pattern, for example). Once the “gesture mode” is activated, the application 100 enables the user 202 to enter non-text input related to emotional content by drawing, using motions or gestures, moving the device 14 in a certain manner (e.g., shaking the phone, where the client 14 comprises a smartphone), and/or the like. The gesture page 350 shown in FIG. 3A comprises a gesture board 352 configured to receive a sender user's 202a non-text input. For example, in at least one exemplary embodiment, the gesture board 352 is displayed on a touchscreen of the client device 14. Alternative examples of embodiments of UIs comprising a gesture page 350 are shown in FIGS. 3C-3E, certain aspects of which (content or output value menu 320, input value 402, and output value 410, for example) are described in additional detail below.

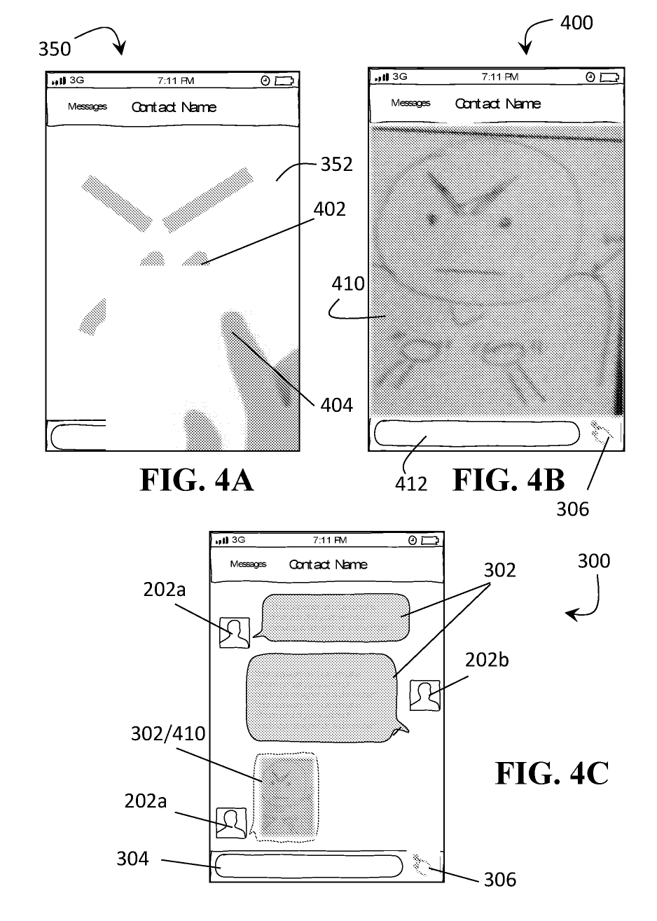

In at least one embodiment of the application 100, a sender user 202a can enter non-text input value 402 that is indicative of an emotion or mood into the gesture board 352 by drawing a gesture or symbol thereon, or otherwise entering it directly using his or her finger, a stylus (not shown), or the like. Additionally or alternatively, where the client 14 comprises haptic technology, the sender user 202a can enter non-text input value 402 into the gesture board 352 indirectly by moving the phone through a motion gesture. FIG. 4A illustrates at least one embodiment of a sender user 202a entering non-text input value 402 directly into the gesture board 352 using his or her finger 404.

After a sender user 202a enters the non-text input value 402 into the gesture board 352, the electronic messaging application 100 may optionally direct the processor to execute the application 100 to provide verification feedback 410 to the sender user 202a regarding the received input value 402, either in the form of displaying a visual representation of the output value 410 identified as being associated with the particular non-text input value 402 values received or simply displaying a query or a general statement mirroring the received input value 402 (such that a sender user 202a can verify it was entered/received correctly). FIG. 4B shows at least one UI of a verification page 400 displaying associated output value 410 for sender user's 202a review and approval.

To identify the appropriate output value 410 that corresponds with the input value 402 received, in at least one embodiment, the electronic messaging application 100 directs the processor to execute the application 100 to access one or more databases (not shown) of the system 200 where interpretation data is stored. Such databases may comprise local storage or data structures with respect to the client 14, data structures associated with the server 12 and/or accessible via the network 16 or otherwise, and/or cloud-based data structures accessible via the network 16.

The interpretation data may comprise stored data regarding associations between particular non-text input values 402 and pre-defined visual output values 410 associated therewith. For example, in at least one embodiment, the interpretation data stored in the database(s) supports an association between the non-text input value 402 illustrated in FIG. 4A and the output value 410 shown in FIG. 4B (i.e. the image of a person shaking his fists). As will be described in additional detail below, data associations may be defined by the sender user 202a, the system 200 (such as default settings, for example), or any combination thereof.

Accordingly, upon receipt of non-text input value 402 into the gesture board 352, the electronic messaging application 100 directs the processor to execute the application 100 to compare the received input value 402 values with the interpretation data saved in one or more designated database(s) in order to identify the corresponding output value 410. Once the corresponding output value 410 is identified, the application 100 displays the output value 410 to the sender user 202a for verification purposes prior to transmission (see, for example, FIG. 4B, where user 202a can also enter a text-based communication into field 412 prior to transmission). If satisfactory, the user 202a can then send the output value 410 (i.e. the visual image associated with an emotion/input value 402) by hitting a send button 306 or performing a specific gesture or input series (e.g., tapping the screen or shaking the client 14 device). Alternatively, as desired, the application 100 may be configured to automatically transmit the identified output value 410 to the identified recipient user 202b once an association is made between the input value 402 and the stored interpretation data.

FIG. 4C shows at least one embodiment of a UI 300 showing a message thread between the sender user 202a and the recipient user 202b where the electronic messaging application 100 has been employed to convey emotional context in connection with the users' 202a/202b IM chat. Here, the chat not only comprises text-based messages 302, but also message 302/410, which incorporates the output value 410 produced by sender user's 202a use of the gesture board 352 (i.e. the “emotional content”). In this manner, from the recipient user's 202b perspective, as soon as the sender user 202a sends the emotional content, the recipient user 202b receives the same in real or near-real time and can immediately interpret any text-based communication in light of the emotional content. Furthermore, it will be appreciated that through use of the application 100, text-based communication need not be employed at all; indeed, users 202a, 202b may consist of—and users 202a, 202b may communicate solely using—the emotional content produced using the application 100.

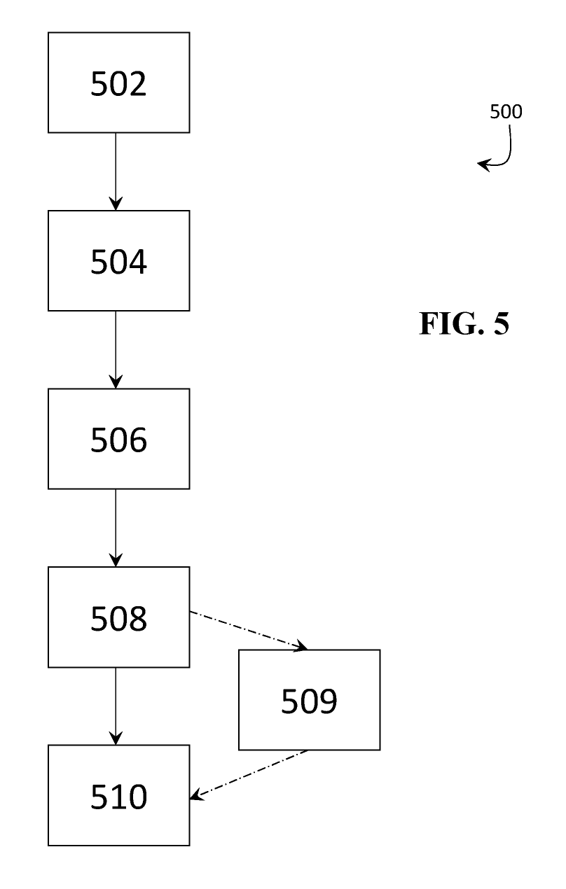

Now referring to FIG. 5, a flow chart representative of at least one embodiment of an exemplary method 500 for communicating emotions during a text-based communication session using the electronic messaging application 100 is shown. At step 502, one or more users 202 activate the electronic messaging application 100. Activation of the electronic messaging application 100 may be achieved by a user 202 selecting “gesture mode” or otherwise executing the application 100 as is known in the art. It will be appreciated that, in certain embodiments where the application 100 is implemented as an integral component of the underlying messaging platform, step 502 need not be performed and the method 500 will initiate at step 504.

During an electronic communication session between one or more users 202, when a sender user 202a desires to send emotional content to the recipient user 202b, the method 500 advances to step 504 when the sender user 202a accesses the application 100 and the gesture board 352 is displayed. At step 506, the sender user 202a enters an input value 402 that is indicative of an emotion or mood into the gesture board 352. As previously described, this can be accomplished through a variety of methods including, without limitation, by drawing a gesture or symbol on the gesture board 352, gesturing adjacent to the client 14 device, and/or gesturing with the client 14 device.

After a sender user 202a enters the input value 402 at step 506, the method 500 advances to step 508. At step 508, the processor executes the electronic messaging application 100 such that the application 100 identifies an output value 410 associated with the particular input value 402 received at step 506 using, in at least one embodiment, interpretation data stored in one or more accessible databases or data structures. The application 100 may identify the appropriate output value 410 through the use of various algorithms and comparisons as previously described herein or as is otherwise known in the art.

When the appropriate output value 410 is identified by the application 100, the method 500 advances to step 510 or, optionally, may first advance to intermediate step 509 pursuant to sender user 202a preference (for example, a user 202 may establish preferences with the application 100 upon its initial set-up and/or installation). At optional step 509, the application 100 is executed by the processor to provide verification feedback to the sender user 202a to confirm that the input value 402 was entered correctly and the appropriate output value 410 was identified. Such verification feedback may comprise a visual representation of the output value 410 identified by the application 100 as being associated with the entered input value 402 or a general statement mirroring/confirming the input value 402 and/or describing the identified output value 410. This optional step 509 may also provide an opportunity for the sender user 202a to enter additional text communication to be sent to the recipient user 202b in conjunction with the emotional content. When the sender user 202a is satisfied with the output value 410 (as may be indicated by the sender user 202a hitting a “send” button 306 or otherwise selecting to publish or transmit the content), the method advances to step 510.

At step 510 of the method 500, the processor executes the electronic messaging application 100 to transmit the identified emotional content/output value 410 to the recipient user 202b. It will be appreciated that the recipient user 202b may receive the output value 410 in real or near-real time. Furthermore, due to the nature of the output value 410, the recipient user 202b can immediately interpret the output value 410 in light of the emotional content thereof (i.e. read the emotional cues).

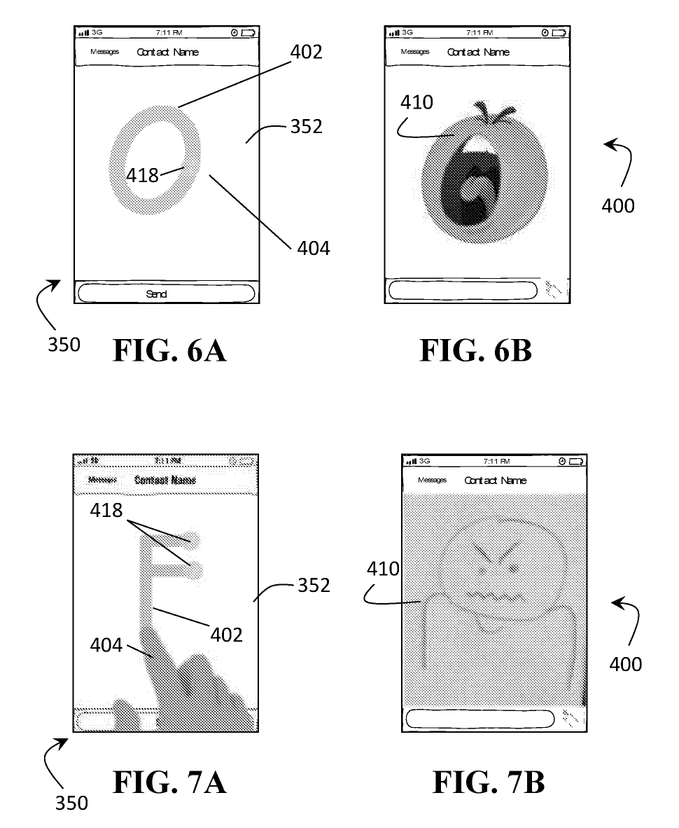

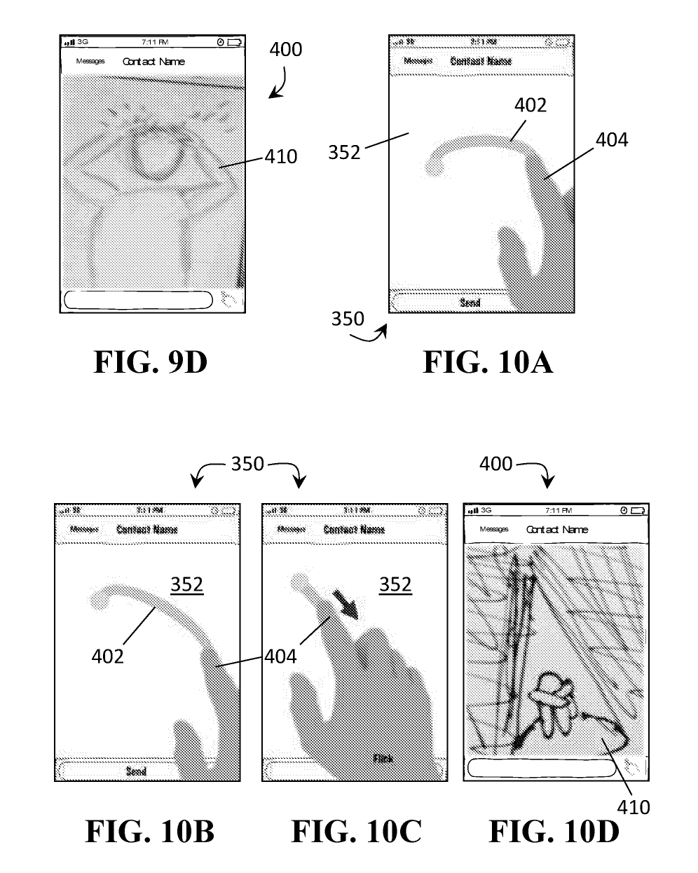

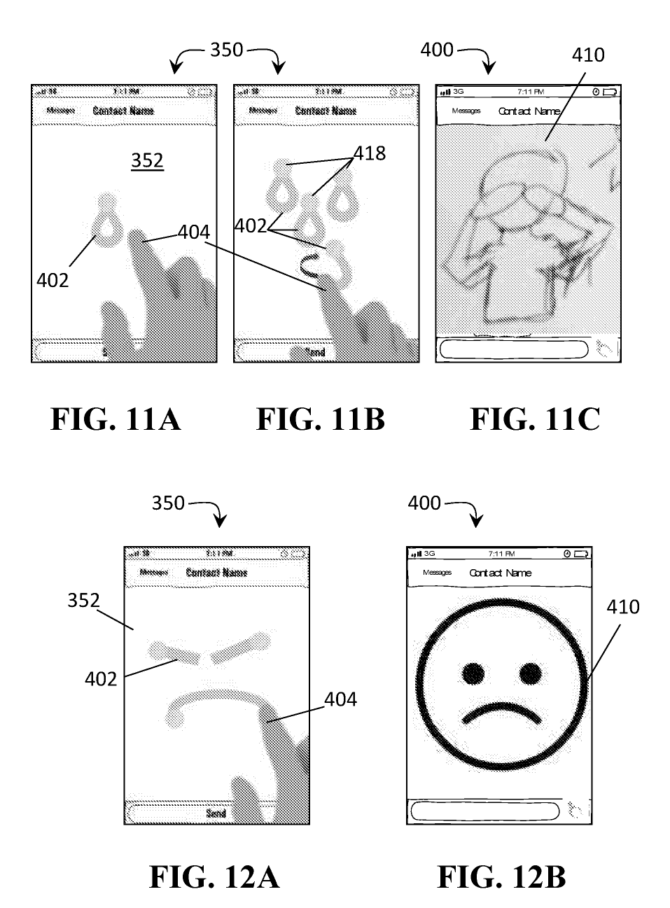

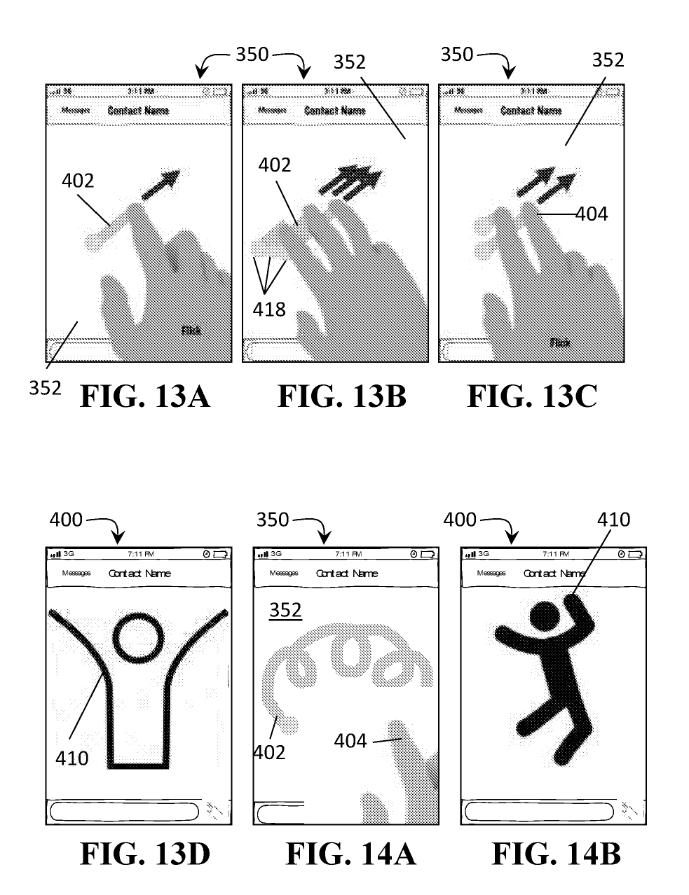

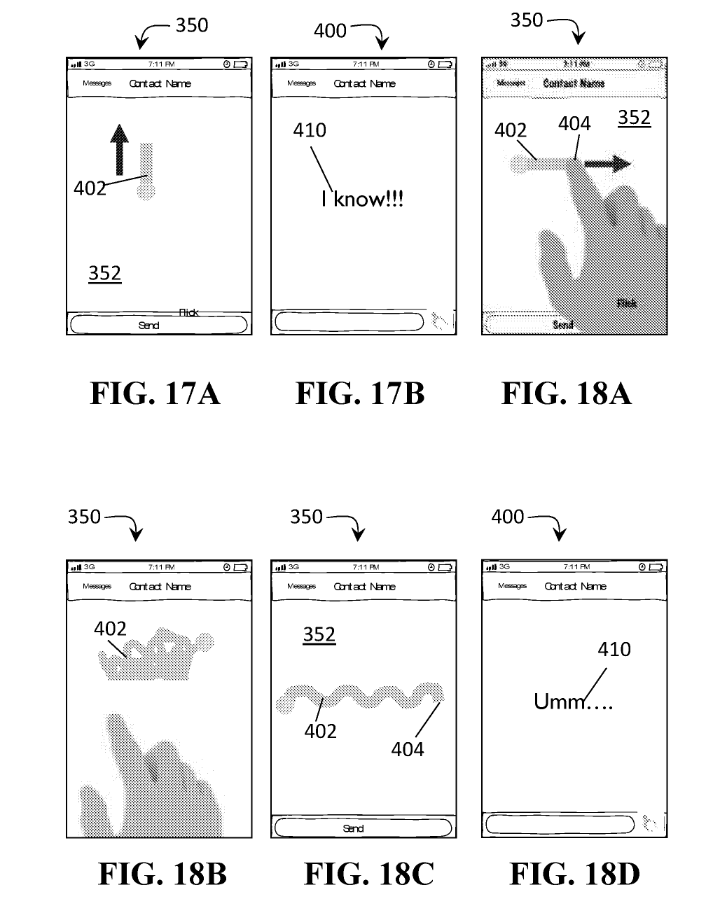

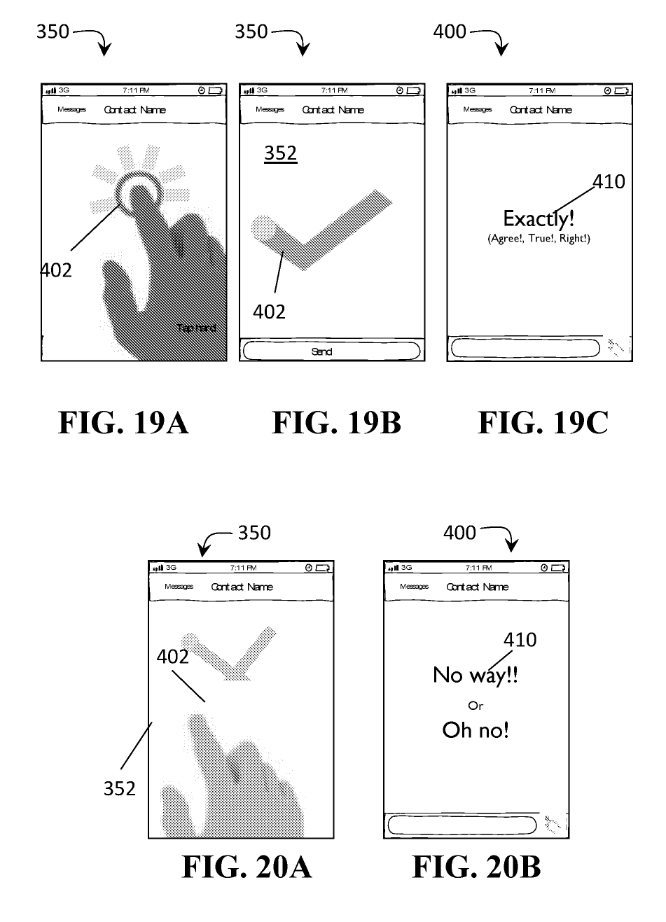

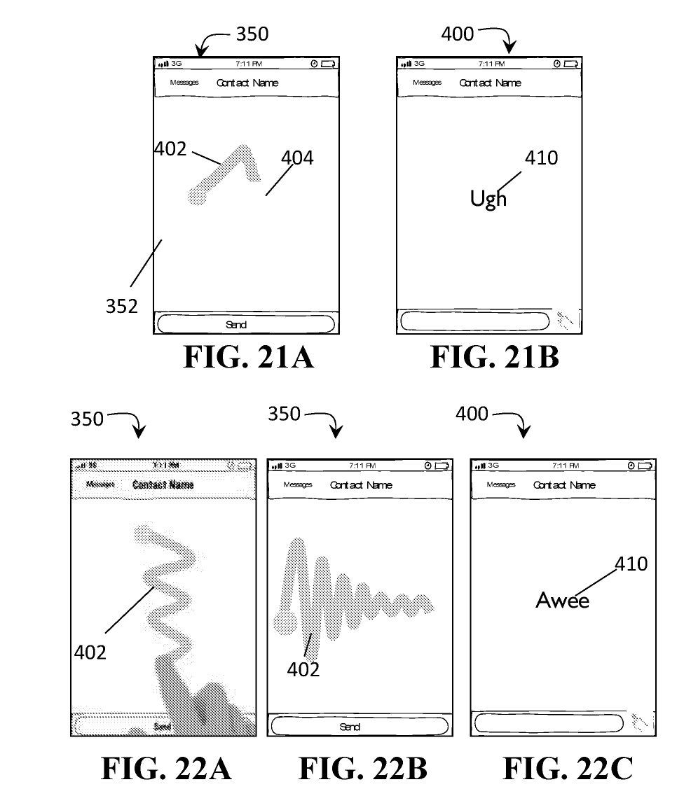

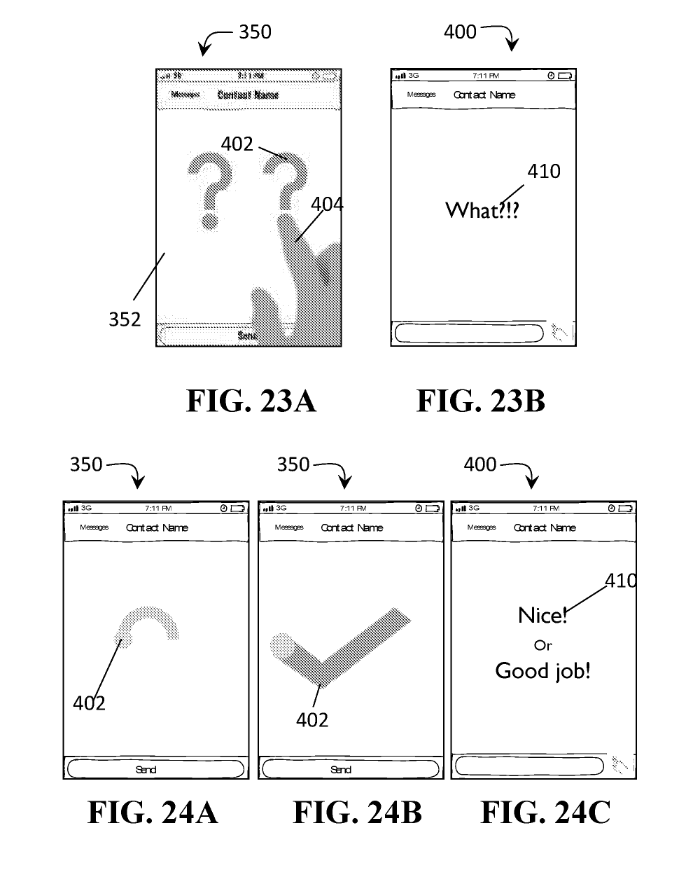

Now referring to FIGS. 6A-24C, UIs of the gesture page 350 and verification page 400 are shown by way of example to illustrate the various ways in which a non-text input value 402 may be entered into the gesture board 352 and thereafter interpreted by the electronic messaging application 100 to result in a particular output value 410. As shown in FIG. 5A, a sender user 202a may use his or her finger 404 to enter the non-text input value 402 (here, a graphical representation is entered directly onto the gesture board 352 front a single initiation point 418). Upon processing the input value 402 in connection with the interpretation data, the electronic messaging application 100 identifies and displays the corresponding output value 410 on verification page 400 as shown in FIG. 5B.

It will be appreciated that an unlimited number of input values 402 and output values 410 may be associated and stored in the interpretation data for use by the application 100. In this manner, the application 100—and the associations between input values 402 and output values 410 made thereby—is fully customizable by the users 202. For example, a sender user 202a may establish an association between the particular of input value 402 design and a particular output value 410. This association may then be saved with the interpretation data such that when the sender user 202a enters that particular design as an input value 402, the application 100 will identify the associated output value 410 and display the same. FIGS. 7A and 7B illustrate two variations of one input value 402 that a user 202a has associated with the particular output value 410 shown in FIG. 7C.

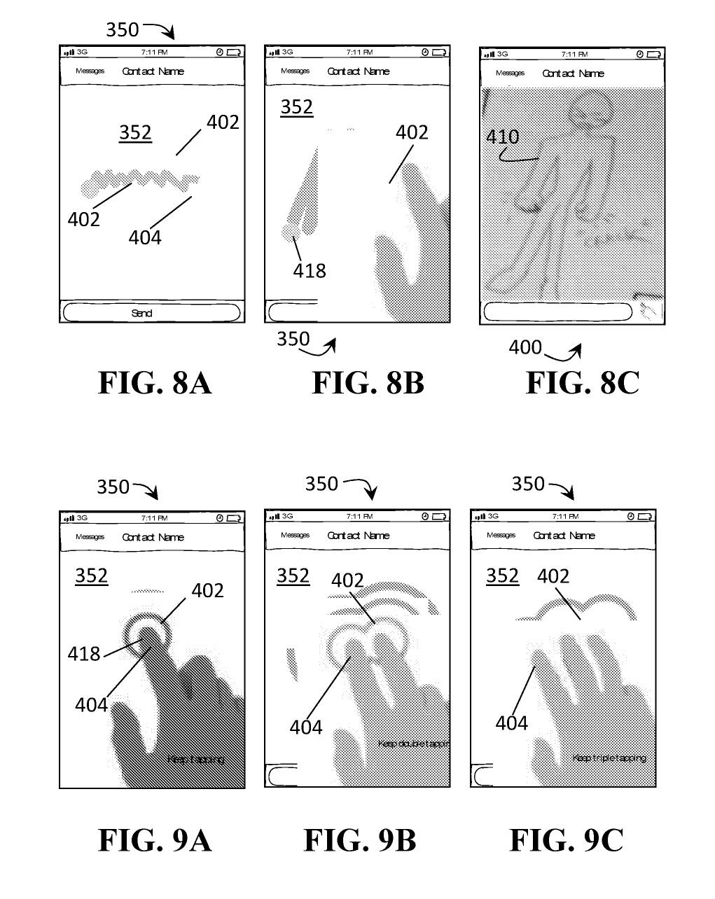

Variations of input and output values 402, 410 are limited only by a user's 202 imagination and the functionality of his or her underlying client device 14. For example, and without limitation, input values 402 may comprise one or more initiation points 418 and/or multi-touch gestures (FIG. 6A illustrates two initiation points 418, whereas FIGS. 8C and 10B illustrate examples of three initiation points 418); be entered by sliding touch (see FIGS. 7A, 7B, 9A-9C, 10A-10B, 12A-12C, 13A, 15A-15B, 16A, 17A-17C, and 18B, for example), tapping touch (see FIGS. 8A-8C, with each concentric ripple around an initiation point 418 representative of a single tap, thus indicating the finger(s) 404 tapped three times in each FIG. 8A-8C), any other type of touch that may be received and distinguished by the gesture board 352, and/or any combination of the foregoing (see FIG. 14A, for example, of a combination of tapping and sliding touch); be entered by visualizing gestures performed adjacent to the client 14, but not in direct contact therewith (i.e. a sender user 202a gesturing his or her hands in front of a camera or other visual input device of the client 14 that is accessible via the gesture board 352); and/or be entered by moving the client 14 or a component thereof in a particular fashion (i.e. utilizing haptic technologies (non-contact or contact)) such as shaking, for example.

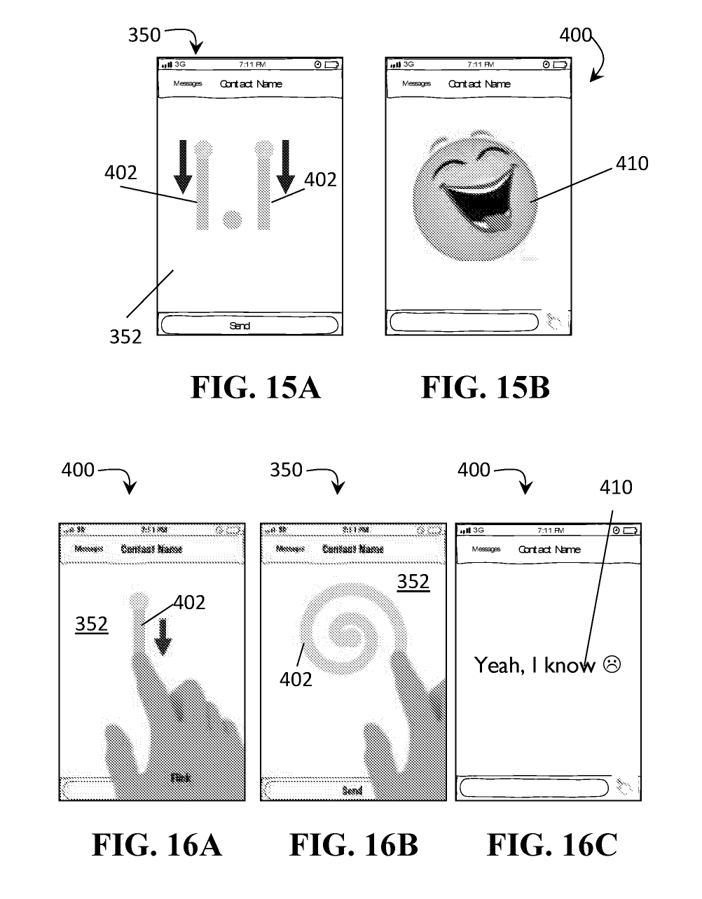

Likewise, in at least one embodiment of the application 100, not only may a sender user 202a define which input values 402 are to be associated with particular emotional content/output values 410, but the look and feel of the visual output values 410 themselves may also be fully customizable by a sender user 202a. Examples of certain output values 410 are shown in the Figures and may include, without limitation, hand-drawn images (see FIGS. 6B, 7C, 8D, 9D, etc.), computer graphics (see FIGS. 5B, 11B, 12D, 13B, and 14B), text or a combination of text and graphics (see FIGS. 15C, 16B, 17D, and 18C), or any other visual representations that can be stored in or accessed by the interpretation data and displayed via the client 14. Output values 410 may also (or alternatively) comprise haptic feedback such as vibrations and the like. For example, in at least one embodiment, a particular input value 402 may be associated with an output value 410 that comprises a visual component and vibration of the recipient user's 202b underlying client 14 device. Assuming the recipient user's 202b hardware supports the haptic feedback associated with the output value 410, in such an example, upon receipt of the emotional content, the recipient user's 202b device will not only display the value 410, but also vibrate.

Furthermore, the electronic messaging application 100 may be configured to take into account and represent via the output values 410 a degree of emotional intensity with which a sender user 202a associates a particular communication. The degree of intensity may be communicated to and/or interpreted by the application 100 in light of the degree of force a sender user 202a uses in entering an input value 402 to the gesture board 352, the color a sender user 202a chooses to associate with an input value 402, the amplitude of a particular input value 402, or any other degree of measurement that may be defined within the application 100 and measured and/or observed in connection with an input value 402.

In at least one exemplary embodiment, FIGS. 7A and 7B illustrate how a sender user 202a may modify the amplitude of an input value 402 to reflect a desired degree of intensity that should be associated with the related output value 410. While the input values 402 in both FIGS. 7A and 7B reflect the same pattern of input 402 (and, as such will be associated with the same output value 410), the input value 402 entered into the gesture board 352 in FIG. 7A reflects less intensity than does the input value 402 shown in FIG. 7B, which has a larger amplitude and was likely entered with a stronger force. As such, the application 100 can be configured to take this intensity difference into account and reflect the same in the resulting output value 410. For example, the output value 410 resulting from the input value 402 shown in FIG. 7B may be enlarged, depicted with brighter colors, utilize vibrations or stronger vibrations and/or light functionalities of the recipient user's 202b client 14, and/or all capitalized text (where applicable) as compared with the output value 410 resulting from the input value 402 shown in FIG. 7A. In this manner, the electronic messaging application can dynamically and organically incorporate additional emotional content into electronic messaging modalities without delaying communication or even adding steps to the process.

Referring back to the customizable aspects of the electronic messaging applications, systems, and methods of the present disclosure, details regarding how users 202 can customize and/or select output values 410 generated by the electronic messaging application 100 will now be described. As previously noted, the application 100 may comprise predefined settings (or defaults) that associate particular input values 402 with particular output values 410; however, embodiments of the electronic messaging application 100 hereof also provide customization features. Some of the customizations allowed for by the application 100 provide users 202 with complete control over defining input values 402, output values 410 and the associations therebetween. Other embodiments of the application 100 allow for a more guided customization experience.

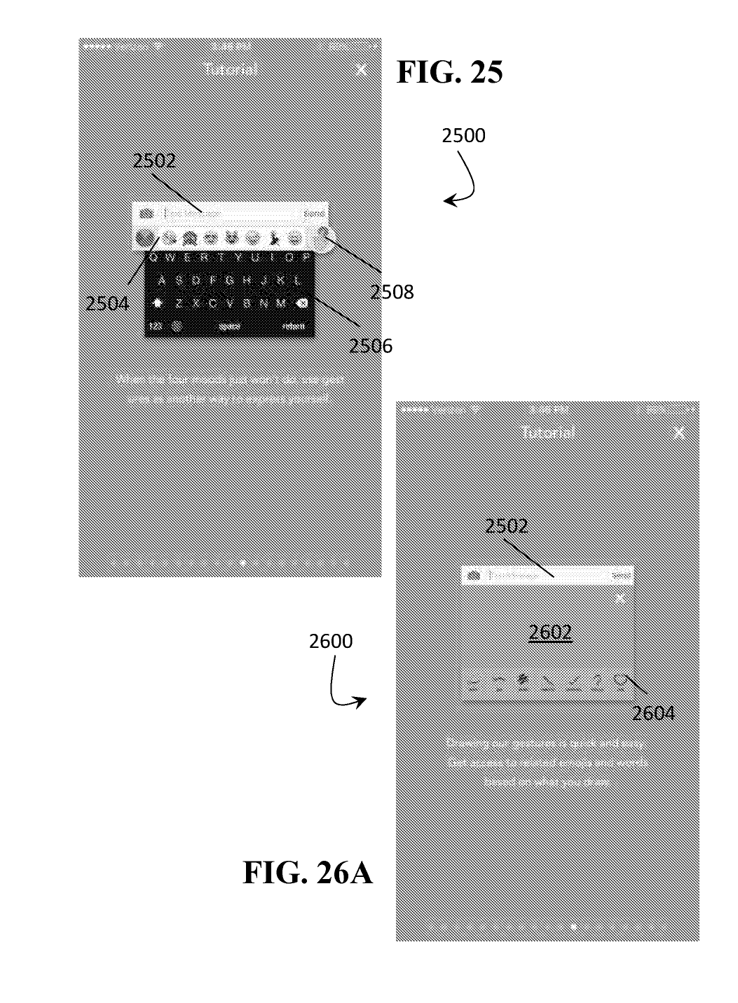

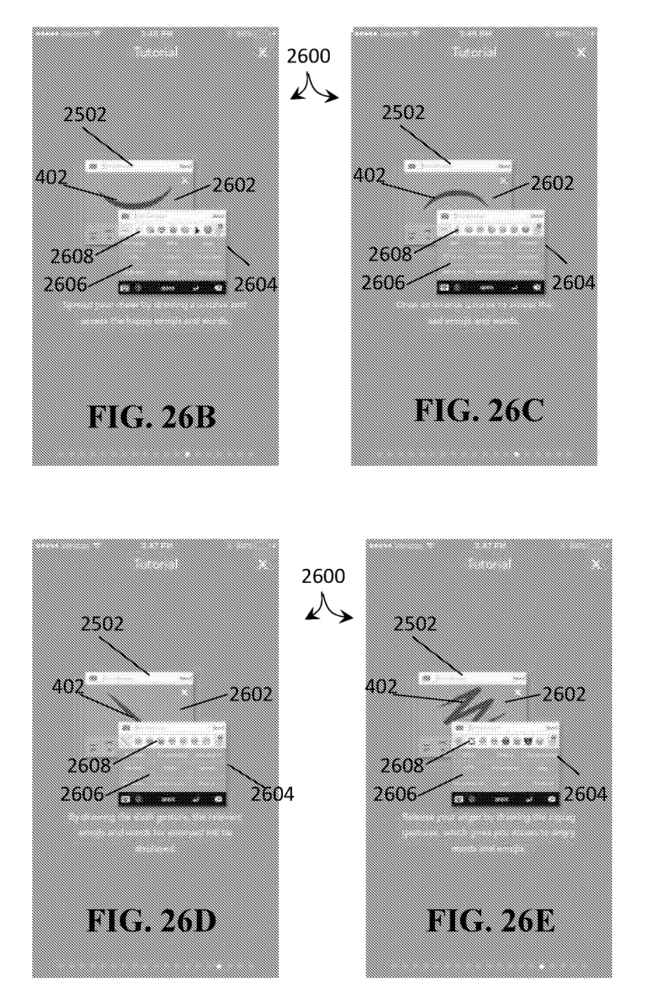

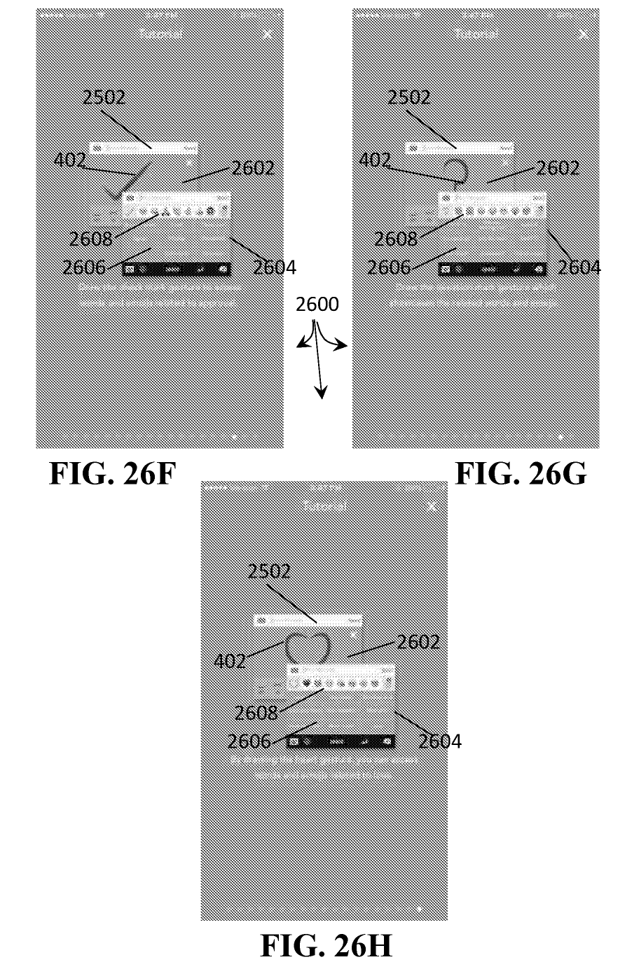

Now referring to FIGS. 25-26H, screenshots of exemplary embodiments of a UI 2500 associated with a customization tutorial of the electronic messaging application 100 are shown. The customization tutorial is functionality that may be provided by the application 100 to assist users 202 in entering and defining various input values 402, output values 410, and making the necessary associations therebetween and is described herein not to only illustrate the tutorial component, but to also provide examples of underlying UIs associated with the application 100 and its various customizable iterations.

The UI 2500 of FIG. 25 is for use in connection with a text messaging platform. The UI 2500 comprises a text message field 2502 for entering text, an emoji menu 2504, a keyboard 2506, and a gesture mode button 2508 (similar to gesture mode button 308 in FIGS. 3B and 3E). The gesture mode button 2508 is at least one embodiment of how a user 202 may easily access and/or activate the electronic messaging application 100 of the present disclosure in connection with an underlying messaging platform.

FIG. 26A illustrates another screenshot of a UI 2600 of a customization tutorial representative of a UI 2600 for assisting a user 202 to establish input and output values 402, 410. This UI 2600 again comprises text message field 2502, but unlike UI 2500, it also comprises an input value entry field 2602 and gesture menu 2604. In at least one embodiment, the gesture menu 2604 provides examples of input values 402 preprogrammed into the application 100 and input value entry field 2602 allows a user 202 to input the same via free hand (similar in certain aspects to previously described gesture board 352). If a user 202 enters an input value 402 into the input value entry field 2602 that has been preprogrammed (and, thus, is recognized by the application 100), the application 100 will immediately provide the user 202 with access to content that is associated with that particular input value 402.

As previously described, the resulting content may comprise a single output value 410 that has been either assigned as a default of the application 100/system 200 or customized by the user 202. However, in at least one exemplary embodiment, the application 100 does not associate a single output value 410 with a particular input value 402, but instead provides multiple relevant options to the user 202 for selection upon the entry of a recognized input value 402. FIG. 26B illustrates at least one embodiment of the UI 2600 where multiple output value options are repented to a user 202 through a content menu 2604. The content displayed in content menu 2604 is associated with the input value 402 entered into the input value entry field 2602 (i.e. a u-curve preprogrammed to access emojis and words associated with the emotion “happy”). FIG. 26C illustrates yet another potential variation of UI 2600 wherein the content displayed in the content menu 2604 is associated with a different input value 402, this time an inverse u-curve that has been preprogrammed to access emojis and words associated with the emotion “sad.” FIGS. 26D-26H show various examples of input values 402 and content that the application 100 has been programmed to associate therewith.

As described herein, the present disclosure provides unique application, systems, and methods that, in addition to providing (and/or working with other platforms to provide) the benefits and conveniences of electronic messaging, enables users to add an additional layer of emotional context to such communications, thereby increasing the understanding and efficiency of electronic communication methods and providing a more satisfactory experience overall. Furthermore, the applications, systems and methods are highly customizable, easy to use, and can establish a modality through which users can associate particular outputs (e.g., graphical images) with specific user-defined motion and/or gesture inputs. In this manner, the present disclosure provides a customizable experience that further facilitates the conveyance of emotional communication via electronic messaging.

While embodiments of the applications, systems, and methods provided herein have been described in considerable detail herein, the embodiments are merely offered by way of non-limiting examples. It will therefore be understood that various changes and modifications may be made, and equivalents may be substituted for elements thereof, without departing from the scope of the disclosure. Indeed, this disclosure is not intended to be exhaustive or to limit the scope of the disclosure.

Further, in describing representative embodiments, the disclosure may have presented a method and/or process as a particular sequence of steps. However, to the extent that the method or process does not rely on the particular order of steps set forth herein, the method or process should not be limited to the particular sequence of steps described. Other sequences of steps may be possible. Therefore, the particular order of the steps disclosed herein should not be construed as limitations of the present disclosure. In addition, disclosure directed to a method and/or process should not be limited to the performance of their steps in the order written. Such sequences may be varied and still remain within the scope of the present disclosure.

1. A system for communicating emotions during a text-based communication session between at least a first user and a second user, the system comprising:
an environment comprising a means for transmitting data between a first user device and a second user device, the means comprising at least electronic messaging functionality; and
a first user device associated with the first user and a second user device associated with a second user, each user device comprising:
a processor in communication with at least one storage device and comprising software,
at least one input component configured to receive an input value comprising a touch or motion gesture at least through a touchscreen or a haptic interface, and
an application for execution with the software, the application in communication with at least one database and configured to:
(a) receive an input value entered through the at least one input component of the device,
(b) pursuant to a predefined rule, associate the received input value with an output value comprising a visualization representative of the input value, and
(c) transmit the output value to the other user.

2. (canceled)

3. The system of claim 1, wherein the received input value further comprises an emotional cue.

4. (canceled)

5. The system of claim 3, wherein the output value further comprises a force representative of the emotional cue of the received input value.

6. (canceled)

7. The system of claim 3, wherein a visual element of the output value is representative of a degree of intensity associated with the emotional cue.

8. The system of claim 7, wherein the visual element comprises an increased size of the visualization of the output value when the degree of intensity associated with the emotional cue is high relative to a standard intensity value.

9. The system of claim 7, wherein the visual element comprises a decreased size of the visualization of the output value when the degree of intensity associated with the emotional cue is low relative to a standard intensity value.

10. The system of claim 5, wherein a force element of the output value is representative of a degree of intensity associated with the emotional cue.

11. The system of claim 10, wherein the force element comprises an increased vibrational force associated with the output value when the degree of intensity associated with the emotional cue is high relative to a standard intensity value.

12. (canceled)

13. The system of claim 1, wherein the input value comprises tracing a u-curve shape on the at least one input component and the output value comprises a menu of visualizations and words representative of an emotion comprising happiness.

14. The system of claim 1, wherein the input value comprises tracing an inverted u-curve shape on the at least one input component and the output value comprises a menu of visualizations and words representative of an emotion comprising sadness.

15.-18. (canceled)

19. The system of claim 1, wherein the input value comprises tracing a heart shape on the at least one input component and the output value comprises a menu of visualizations and words representative of an emotion comprising love.

20.-23. (canceled)

24. A method of communicating emotions during a text-based communication session between at least a first user and a second user, the method comprising the steps of:
inputting, by a first user, one or more emotional cues through touch or motion gestures on an input component of a first user device; and
transmitting the one or more inputted emotional cues to a second user, wherein the second user receives an output value comprising at least one of a visualization or a vibration that corresponds with the one or more emotional cue inputted by the first user.

25.-32. (canceled)

33. The method of claim 24, further comprising the step of associating a degree of intensity with the one or more emotional cues inputted by the first user.

34. The method of claim 33, further comprising the step of displaying the output value to the second user, wherein a visual element of the output value is representative of the degree of intensity associated with the one or more emotional cues inputted by the first user.

35. The method of claim 33, wherein a visual element of the output value received by the second user is representative of the degree of intensity associated with the one or more emotional cues inputted by the first user.

36.-39. (canceled)

40. The method of claim 24, wherein the step of inputting further comprises:
displaying a menu of visualizations and words representative of the one or more emotional cues; and
selecting, by the first user at least one of the visualizations or words on the menu for inclusion in the output value.

41. The method of claim 40, wherein the step of inputting comprises tracing, by the first user, a u-curve shape on the input component and the visualizations and words are representative of an emotion comprising happiness.

42. The method of claim 40, wherein the step of inputting comprises tracing, by the first user, an inverted u-curve shape on the at least one input component and the visualizations and words are representative of an emotion comprising sadness.

43.-46. (canceled)

47. The method of claim 40, wherein the step of inputting comprises tracing, by the first user, a heart shape on the at least one input component and the visualizations and words are representative of an emotion comprising love.

48. (canceled)

49. (canceled)

50. A software application for communicating emotions during a text-based communication session between at least a first user and a second user, the application comprising:
executable program codes operable to (a) receive an input value entered through the at least one input component of the device, (b) pursuant to a predefined rule, associate the received input value with an output value comprising a visualization representative of the input value, and (c) transmit the output value to the other user.
